(19) United States
(12) Patent Application Publication
(10) Pub. No.: US 2004/0029285 A1
(43) Pub. Date: Feb. 12, 2004

(54) Apparatus and method for drug discovery based on intrinsic protein fluorescence

(76) Inventors: Salvador M. Fernandez, Hartford, CT (US); Christopher P. Hanna, Somerville, MA (US)

Correspondence Address: ALIX YALE & RISTAS LLP, 750 MAIN STREET, SUITE 1400, HARTFORD, CT, 06103, US

(21) Appl. No.: 10/256,325

(22) Filed: Sep. 27, 2002

Related U.S. Application Data
(60) Provisional application No. 60/325,932, filed on Sep. 28, 2001.

(51) Int. Cl. G01N 21/64

(52) U.S. Cl. 436/86; 422/82.08; 436/172

(57) ABSTRACT

A phase fluorometer apparatus and method for protein dynamics characterization where a sample is excited with a polarized light, sinusoidally modulated at a single frequency, and the phase difference between polarization components of the emission is detected and processed. The phase difference depending on the modulation frequency, the rate of fluorophore rotation, and the freedom and isotropy of these rotations. The apparatus and method allows information to be collected on the time dependence of the emission anisotropy of a protein of interest and further allows for a ranking of proteins relative to each other.

### CROSS REFERENCE TO RELATED APPLICATION

This application claims the priority of U.S. Provisional Application No. 60/325,932, filed on Sep. 28, 2001.

### FIELD OF THE INVENTION

This invention relates to fluorescence assays and in particular to instrumentation and methods for performing assays based on frequency-domain measurements of intrinsic protein fluorescence polarization and fluorescence lifetime.

### BACKGROUND OF THE INVENTION

Proteomics has presented the pharmaceutical industry with an explosion in the number of protein targets available for therapeutic drug development and, at the same time, advances in combinatorial chemistry and high-throughput organic synthesis have increased the number of compounds available for testing to unmanageable levels. This problem is putting such enormous demands on the already inefficient discovery process that lead identification and optimization have been identified as the major bottleneck of modern high-throughput drug discovery Baxter, A. D. and P. M. Lockey, ‘Hit’ to ‘Lead’ or ‘Lead’ to ‘candidate’ optimisation using multi-parimetric principles. 2001: p. 9-10. While the production of targets was once the bottleneck in drug discovery, this has now been superseded by the requirement for high-quality compounds that can accurately and specifically hit these targets Kessman, H. and H. Ottleben, A Short Cut On The Long Road To Drug Discovery, In Innovations In Pharmaceutical Technology. 2001. p. 24-27.

One way in which the pharmaceutical industry has responded to the challenge of lead discovery and optimization has been to implement high-throughput screening (HTS) assays of ever increasing scale. However, synthesizing practically unlimited number of organic compounds spanning as much chemical space as possible is no longer the most cost-effective and time-saving approach to hit identification.

New improved methods are needed for drug discovery that can be automated, are cost-effective and optimally explore the vast chemical space available for drug design. A powerful approach that increases the quality of new leads when the structure of the target is known is in silico screening and rational design Lengauer, T. and M. Rarey, Computational Methods For Biomolecular Docking. Curr Opin Struct Biol, 1996. 6(3): p. 402-6. Gschwend, D. A., A. C. Good, and I. D. Kuntz, Molecular Docking Towards Drug Discovery. J Mol Recognit, 1996. 9(2): p. 175-86. In this type of structure-based ligand design, optimization methods are used to rank compounds by means of a scoring function that is related to the interaction energy between a drug molecule and its binding site. Computational analysis of large real or virtual chemical databases can readily identify compounds with appropriate properties for binding to the target protein. Full receptor ligand docking represents the most detailed approach to virtual screening.

Molecular docking has important advantages. Although it may only have limited ability to discriminate between two compounds that both fit in an active site, it can reliably screen out compounds that do not fit in a binding site or that have grossly wrong electrostatic properties. This allows for a marked reduction in the size of the compound library before undertaking experimental assays. Also, docking may be used to screen compounds for which there is no actual physical sample at hand, and a docking hit comes with a prediction of geometry, which allows for compound optimization in the context of the binding site. However, despite these significant benefits, molecular docking as a screening method, presently suffers from a number of limitations which lead to false positives and false negatives. For example, the scoring functions are inaccurate, the sampling of conformational states is coarse, and many solvent-related terms are often ignored. Bissantz, C., G. Folkers, and D. Rognan, Protein-Based Virtual Screening Of Chemical Databases. 1. Evaluation Of Different Docking/Scoring Combinations. J Med Chem, 2000. 43(25): p. 4759-67. Charifson, P. S., et al., Consensus Scoring: A Method For Obtaining Improved Hit Rates From Docking Databases Of Three-Dimensional Structures Into Proteins. J Med Chem, 1999. 42(25): p. 5100-9. Knegtel, R. M. and M. Wagener, Efficacy And Selectivity In Flexible Database Docking. Proteins, 1999. 37(3): p. 334-45.

The discovery of drug lead compounds by in silico ligand docking methods may be significantly improved by integrating into the virtual screening process experimental characterization of target conformation and molecular dynamics. The reason is that static three-dimensional structures alone often do not illuminate the path for rational drug design. Kay, L. E., Protein Dynamics From NMR. Biochem Cell Biol, 1998. 76(2-3): p. 145-52. A three-dimensional static structure provides a description of the ground state of the molecule. However, macromolecular function is, often, highly dependent on excursions to excited molecular states and hence intimately coupled to flexibility. Moreover, in terms of bioenergetics, a significant component of molecular stability derives from motion.

A protein in solution undergoes constant random thermal motions within a stable equilibrium structure. Many proteins also undergo thermally driven transitions, conformational changes, between two or more equilibrium structures. Both types of motion can play important functional roles. Random thermal motions and the average conformation can both change substantially when a protein is modified by substrate or ligand binding, and such changes often have important functional consequences for the tuning of binding affinities. Falke, J. J., A Moving Story. Science, 2002. 295: p. 1480-1481. Therefore, a more complete and much more useful description of the ligand-target interaction can be obtained when ligand-induced effects on target conformation and molecular dynamics are included in the screening process. Kay, L. E., Protein Dynamics From NMR. Biochem Cell Biol, 1998. 76(2-3): p. 145-52. This improvement results in better quality drug leads.

Measurements of protein intrinsic fluorescence dynamics conventionally require complex instrumentation, slow data collection and complex data analysis. One of the requirements for such a system is an RF-modulated or nanosecond-pulsed light source capable of providing excitation near 280 nm spectral range. For example, a typical light source used for exciting native protein fluorescence might be a frequency-doubled dye laser, which is synchronously pumped by a mode-locked laser (complex operation, considerable maintenance, critical alignment); detection uses the time-correlated single-photon counting method (slow data collection), and data analysis requires deconvolution (additional complexity and time). While these approaches work well for biophysical research of one protein at a time, they are not suitable for screening huge combinatorial libraries in conjunction with computational methods.

### SUMMARY OF THE INVENTION

In brief, a phase fluorometer apparatus and method for protein dynamics characterization in accordance with the invention whereby a sample is excited with polarized light, sinusoidally modulated at a single frequency, and the phase difference between polarization components of the emission are detected and processed. The phase difference depends on, for example, the modulation frequency, the rate of fluorophore rotation, and the freedom and isotropy of these rotations. This apparatus and method allow information on the time dependence of the emission anisotropy of a particular protein to be collected and a ranking of proteins to be established for the purpose of drug lead development.

In accordance with the present invention, an excitation light source having a means for generating an excitation light energy, for example, a deuterium lamp, laser, filtered light module or other light source known in the art which can produce an emission for causing a fluorescent emission from a sample. The excitation light source may in an embodiment of the invention be a deuterium light source rich in short wavelength ultraviolet light. The excitation light source is directed down an excitation energy pathway that extends from the excitation source to a sample. A means for modulating the excitation light source to a desired frequency. The sample is then excited with the modulated excitation light source and the fluorescent emission from the sample is detected by a detection means. The detection means allows a first polarization component such as for example a perpendicular component to be detected. The detection means also allows a second polarization component such as, for example, a parallel component to be detected. The emission from the sample travels from the sample along an emission pathway extending from the sample to the detector means. The detector means generates detection signals, which are sent to a processing means. The processing means processes the detection signal to yield a modulation amplitude for the first polarization component and for the second polarization component. Polarization may be accomplished by polarizers which are disposed in the excitation energy pathway emission pathway. Additionally, polarizers may be disposed in a first polarization component pathway extending from the sample to the first polarization component detector and polarizers disposed in a second polarization component pathway extending from the sample to the second polarization component pathway.

In accordance with the present invention, a method of phase fluorometery for protein dynamics characterization comprising exciting a sample with a polarized modulated deuterium light source detecting an emission from said sample at a first polarization angle and a second polarization angle generating a first polarization angle signal and a second polarization angle signal processing said first polarization angle signal and second polarization angle signal.

It is an object of the present invention to enhance the accuracy of in silico ligand docking methods by integrating into the virtual screening process experimental characterization of target conformation and molecular dynamics. The present invention accomplishes this through frequency-domain measurement and analysis of intrinsic protein fluorescence observables that report on the environment and mobility of fluorescent amino acid residues such as tryptophan residues.

It is a further objective of the present invention to enable homogeneous assays that do not require extrinsic labels but that have high sensitivity and can be implemented with relatively inexpensive, robust, simple-to-operate instrumentation.

An objective of the present invention is to enhance the accuracy of in silico ligand docking methods by integrating into the virtual screening process experimental information on target conformation and molecular dynamics obtained through frequency-domain measurement and analysis of intrinsic protein fluorescence observables that report on the environment and mobility of tryptophan residues. The invention comprises two aspects, a method and an apparatus to implement the method.

According to the present invention, dynamic characterization of the target proteins is performed through measurements of intrinsic protein fluorescence. Proteins contain three amino acid residues, tryptophan, tyrosine and phenylalanine, which may contribute to their intrinsic fluorescence, but tryptophan is the dominant intrinsic fluorophore. The emission of tryptophan is highly sensitive to its microenvironment, which makes intrinsic protein fluorescence a useful signal for gaining information about protein structure and rotational motions, Munro, 1979 #1902; Szabo, 1980 #1706. For example, tryptophan emission maxima can extend from 308 nm to 350 nm, fluorescence lifetimes can range from 0.1 ns to 16 ns, and rotational correlation times can range from a few nanoseconds to over 50 ns, depending on microenvironment. Eftink, M. R., Intrinsic Fluorescence of Proteins, in Protein Fluorescence, J. R. Lakowicz, Editor. 2000, Plenum Publishers: New York. p. 1-13. Generally, a tryptophan residue will exhibit a short and a long correlation time, which correlate with overall tumbling of the protein or rapid segmental motions, respectively. Steiner, R., Flourescence Anisotropy: Theory and Applications, in Topics in Fluorescence Spectroscopy Vol. 2 Principals, J. R. Lakowicz, Editor. 1991, Plenum Press: New York. p. 1-52. Lipari, G. and A. Szabo, Effects Of Liberational Motion on Fluorescence Depolarization And Neucular Magnetic Resonance Relaxation Of Macromoleculesans Membrains. Bioiphys. J, 1980. 30: p. 489-506.

The environmental and motional sensitivity of intrinsic protein fluorophores can be experimentally probed with multidimensional fluorescence measurements. Fluorescence intensity can be measured as a function of excitation or emission wavelength to obtain spectra, or it can be measured as a function of time or frequency to obtain lifetimes. Intensity can also be measured as a function of polarizer angle to obtain information about the rotational motion of the fluorophore. These dimensional axes can be used in combination, for example, with measurements of intensity versus polarizer angle and time to obtain time-resolved anisotropy decays, and hence rotational correlation times. Other advantages of fluorescence include its high sensitivity, which enables analysis of very limited quantities of material since only nanomoles of the analyte is required. Fluorescence is also adaptable to a variety of instrumental configurations such as microwell plates, cuvettes, microscope slides, fiber optics and many others. Measurement speed is also important, since this allows relatively high signal-to-noise data in short times amenable to high-throughput applications.

More specifically, in the present invention differential polarized phase fluorometry (DPPF) Lakowicz, J. R., Principles of Fluorescence Spectroscopy. 1983, New York: Plenum Press. xiv, 496 is used to obtain information on protein dynamics. Differential phase fluorometry provides a method to investigate protein rotational motions.

### BRIEF DESCRIPTION OF THE DRAWINGS

FIG. 1 is a diagram illustrating both a method of determining new drug leads and a method incorporating dynamic characterization for determining new drug leads.

FIG. 2 is a diagram of the embodiment of the invention utilizing a direct source modulation and an example of phase and modulation.

FIG. 3 is a graph of combined modulation patterns.

FIG. 4 is a diagram of the embodiment of the invention utilizing an external optical modulation and an example of phase and modulation.

### DESCRIPTION OF PREFERRED EMBODIMENT

Incorporated herein by reference is U.S. Pat. No. 5,818,582 issued Oct. 6, 1998.

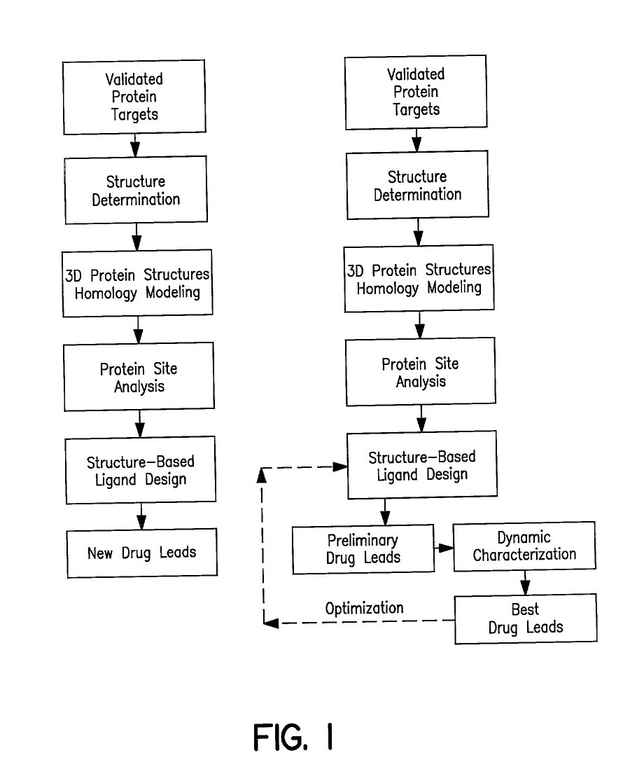

A method for developing new drug leads using structure-based ligand docking techniques is illustrated in FIG. 1. The right panel of FIG. 1 illustrates an embodiment of the present invention wherein information on protein target dynamics is incorporated into a screening process to optimize leads. This incorporation takes place at the box labeled “Dynamic Characterization”.

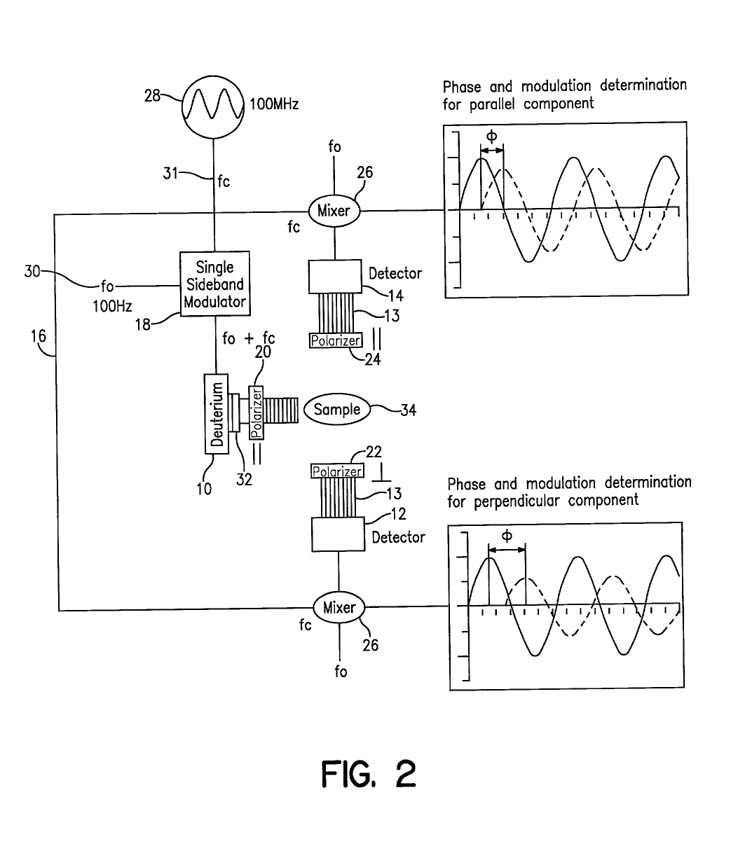

A preferred embodiment of the apparatus of the present invention is shown in FIG. 2.

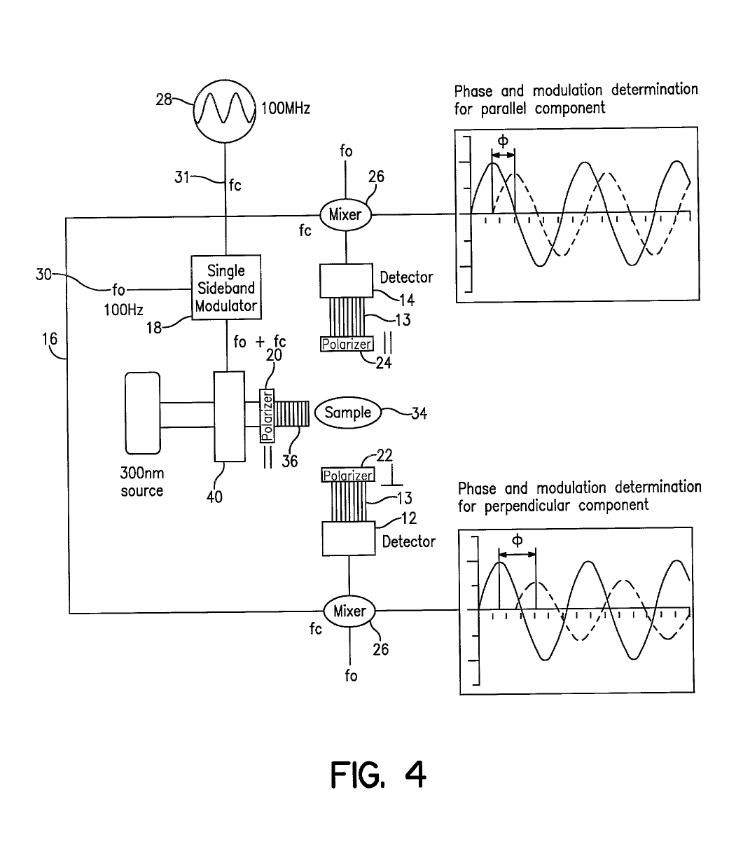

In an embodiment of the invention, a sample 34 is excited by a modulated deuterium light source 10. The lamp may be a modified deuterium lamp having a reduced internal structure to minimize stray capacitance and inductance, and operated with a dc current. RF power may be coupled in through a broadband ferrite transformer as part of a RF matching network 16. The matching network may further have a 100 MHz carrier frequency generator 28 a baseband signal 30 of 400 Hz, a carrier frequency signal 31, and a single sideband modulator 18. The lamp can be directly modulated at frequencies up to 120 MHz with >20% modulation depth, enabling subnanosecond resolution. The lamp is rich in short-wavelength ultraviolet light making it particularly suited for studies of intrinsic protein fluorescence, since tryptophan absorbance peaks near 280 nm. Unlike other modulated broadband sources, this lamp does not require an external optical modulator such as a Kerr cell or a Pockels cell as in FIG. 4, item 40. Therefore, it does not require critical alignment and the light can be efficiently collected with a simple lens. Other advantages include low cost, long operating life and excellent stability. This stability translates directly into a high signal-to-noise ratio in detected fluorescence and allows measurements to be made at much lower light level than would be necessary with an arc source. The excitation light may be polarized by a polarization device 20 which allows light of only a single polarization component to pass. The polarization device may be disposed in the excitation pathway 36 that extends from the excitation light source to the sample.

Detection of the fluorescence employs two channels, one for each polarization in a T-geometry. Polarization devices 22, 24 can be incorporated into embodiments of the invention for example in the emission pathways 13,15, located between the first detector 12 and the sample 34, and between the second detector 14 and the sample 34, respectively. There may be a 300 nm filter 32, or other filter of a desired cutoff, disposed between the light source and the polarization means. Alternatively, single channel detection may be utilized wherein rotation of the polarization means is accomplished for sequential measurement of the two polarization components. For example, rotating the angle to the so-called “magic angle”, 54.7° from the vertical, enables measurements of fluorescence lifetime in the single channel configuration. In some embodiments, a spectral channel not shown in FIG. 2 may be added to monitor any fluorescence emission spectral shifts that may occur upon ligand binding. A signal is generated following detection of the sample emission. The generated detection signal is received by, for example, an RF mixer 26 that allows a phase and modulation determination to be made for each polarization component pathway. For example, the signal from the detection of the polarized fluorescent emission may be then mixed with the carrier signal and then low pass filtered.

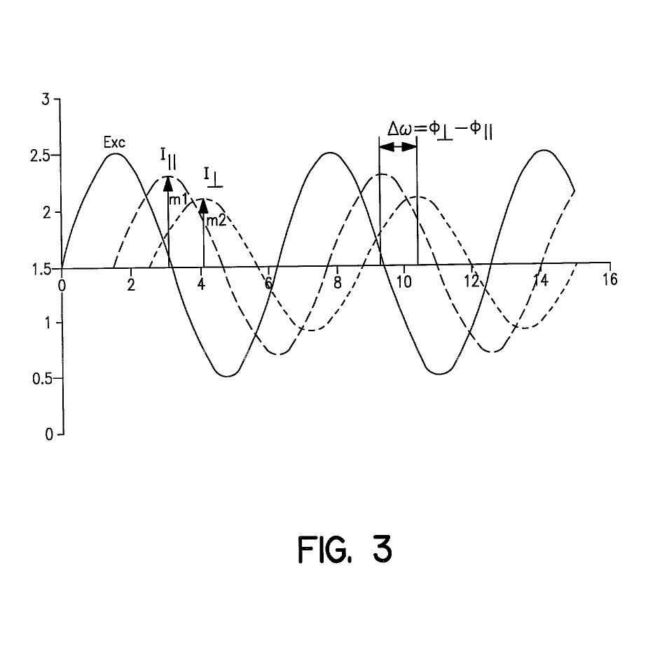

The principle of the DPPF measurement is illustrated in FIG. 3 which shows hypothetical modulation patterns detected at parallel and perpendicular polarization channels. Referring to FIG. 3, m1 and m2 represent the modulated amplitudes of the parallel and perpendicular signals, respectively, and Δω represents the differential polarized phase angle. These parameters are relevant to the assessment of protein dynamics and rotational motions. One means of applying these signal features within phase anisotropy is the calculation of r_{ω} frequency-dependent anisotropy. The calculation may be accomplished for example by first deriving the ratio of the modulated amplitudes, which is defined as Λ_{ω}=m1/m2. The result from this calculation can be used to calculate the frequency-dependent anisotropy r_{ω}=(Λ_{ω}−1)/(Λ_{ω}+2). In an example of a single-frequency implementation, the upward and downward shift in r_{ω} values may serve as a sensitive metric of the upward and downward shifts in the target protein's mean correlation time. Another option is the calculation of Δ_{ω} differential polarized phase angle. The differential polarized phase angle may be defined as Δ_{ω}=φ_{⊥}−φ_{∥}, and will also shift upward or downward as a result of shifts in the target protein's mean correlation time. Whether Δ_{ω} shifts upward or downward depends on the relative values of the lifetime and the individual correlation times. Correlation of the fluorescence observables such as by example lifetime, spectral shifts, frequency-dependent anisotropy, and differential phase angle with inhibitory activity of the ligand compounds provides the basis for interpretation of the fluorescence measurements. From these results a ranking scheme can be established to be used as feedback to virtual screening of large compound databases, as illustrated in FIG. 1.

FIG. 4 shows the directly modulated deuterium lamp employed in the preferred embodiment, the present invention can be implemented with an externally modulated light source 40, such as a broadband source modulated with a Pockels cell or any other suitable modulator device.

While a preferred embodiment of the foregoing invention has been set forth for the purposes of illustration, the foregoing description should not be deemed a limitation of the invention herein. Accordingly, various modifications, adaptations and alternatives may occur to one skilled in the art without departing from the spirit and scope of the present invention.

What is claimed:

1. A phase fluorometer apparatus for protein dynamics characterization comprising:
a deuterium light emitting an excitation light comprising ultraviolet light;
polarizing means for polarizing the excitation light into a single polarization component;
modulating means for modulating the excitation light source comprising
sample baseband signal generator means for generating a baseband signal;
carrier signal generator means for generating a carrier signal; and
up-converting means for combining said baseband signal and said carrier signal to form an up-converted sample signal for modulation of the excitation light source;
an excitation pathway which extends from the excitation source to a sample;
detector means for detection of a sample emission in both a first and a second polarization component;
an emission pathway extending from the sample to the detector means; and
processing means for determining a phase and a modulation for the first polarization component and for the second polarization component.

2. The phase fluorometer apparatus of claim 1, wherein said polarization means is disposed in the excitation pathway.

3. The phase fluorometer apparatus of claim 1, wherein said detector means is a first polarization component detector and a second polarization component detector, said emission pathway being a first polarization component pathway extending from the sample to the first polarization component detector and a second polarization component pathway extending from the sample to the second polarization component pathway.

4. The phase fluorometer apparatus of claim 1, wherein the polarizing means for polarizing the excitation light is disposed in the excitation pathway.

5. The phase fluorometer apparatus of claim 1, wherein said modulating means is an optical modulator.

6. The phase fluorometer apparatus of claim 1, wherein said carrier frequency is 100 MHz and said baseband signal is 400 Hz.

7. The phase fluorometer apparatus of claim 1, said modulating means modulates the light source at frequencies up to 120 MHz with greater than 20% modulation depth.

8. A method of phase fluorometry for protein dynamics characterization comprising:
(a) generating a sample baseband signal at a first frequency;
(b) generating a reference signal correlated to said sample baseband signal;
(c) generating a carrier signal second frequency which is greater than said first frequency;
(d) forming an up-converted sample signal by combining said carrier signal and said baseband signal;
(e) modulating a light source with said up-converted sample signal to form a modulated excitation light;
(f) polarizing the modulated excitation light to form a polarized modulated excitation light;
(g) illuminating a sample with said polarized modulated excitation light.
(h) detecting an emission from said sample at a first polarization angle and a second polarization angle;
(i) generating a first polarization angle signal and a second polarization angle signal; and
(j) processing said first polarization angle signal and said second polarization angle signal to produce modulation patterns from the first and second polarization angle signals;
(k) determining a differential polarized phase angle;
(l) repeating steps (a) through (k) with a standard having a known efficacy; and
(m) ranking the determined differential polarized phase angles of the sample with respect to the standard.

9. The method of phase fluorometry of claim 8, wherein the step of modulating the light source includes generating a short-wavelength ultraviolet light.

10. The method of phase fluorometry of claim 8, wherein the step of modulating the light source does not require external optical modulation.

11. The method of phase fluorometry of claim 8, wherein the step of modulating the light source includes modulating at frequencies up to 120 MHz with a greater than 20% modulation depth.

12. The method of phase fluorometry of claim 8, wherein the step of detecting the emission includes detecting at the first and second polarization angles with separate detectors.

13. The method of phase fluorometry of claim 8, wherein the step of detecting the emission includes the substeps of:
detecting the first polarization angle,
rotating the polarizer 54.7 degrees from vertical; and
detecting at the second polarization angle.

14 The method of phase fluorometry of claim 8, further comprising the steps of:
(n) repeating steps (a) through (k) with additional samples and
(o) ranking the determined differential polarized phase angles of each additional sample with respect to the standard to produce a universe of ranked samples.

15 A method of phase fluorometry for protein dynamics characterization comprising:
(a) generating a sample baseband signal at a first frequency;
(b) generating a reference signal correlated to said sample baseband signal;
(c) generating a carrier signal second frequency which is greater than said first frequency;
(d) forming an up-converted sample signal by combining said carrier signal and said baseband signal;
(e) modulating a light source with said up-converted sample signal to form a modulated excitation light;
(f) polarizing the modulated excitation light to form a polarized modulated excitation light;
(g) illuminating a sample with said polarized modulated excitation light.
(h) detecting an emission from said sample at a first polarization angle and a second polarization angle;
(i) generating a first polarization angle signal and a second polarization angle signal; and
(j) processing said first polarization angle signal and said second polarization angle signal to produce modulation patterns from the first and second polarization angle signals;
(k) determining a modulated amplitude for the first polarization component;
(l) determining a modulated amplitude for the second polarization component;
(m) deriving the ratio of the first modulated amplitude to the second modulated amplitude;
(n) calculating a frequency-dependent anisotropy;
(o) repeating steps (a) through (n) with a second sample; and
(p) ranking the calculations of the frequency-dependent anisotropy of the two samples.

16. A phase fluorometry method for refining computational molecular modeling methods for structure-based drug design comprising the steps of:
a) preparing a sample containing a protein target
b) performing phase fluorometric measurements of differential polarized phase angle and frequency-dependent anisotropy of target protein intrinsic fluorescence to obtain a first set of values for these two parameters
c) adding a test compound to the sample
d) performing phase fluorometric measurements a second time of differential polarized phase angle and frequency-dependent anisotropy of target protein intrinsic fluorescence to obtain a second set of values for these two parameters
e) calculating a response based on a combined measure of the change in these two parameters caused by addition of the test compound
f) comparing said calculated response with the response caused by a standard compound of known efficacy
g) calculating a ranking for the test compound based on its response relative to the standard.

17. The method of claim 16 further comprising the steps of:
h) correlating said ranking with test compound structure to identify favorable structural features
i) providing information on favorable structural features to computational molecular modeling methods for structure-based drug design to improve predictions.
